(19) United States
(12) Patent Application Publication
(10) Pub. No.: US 2002/0081403 A1
(43) Pub. Date: Jun. 27, 2002

(54) Fruit tray pigmented with carbon black

(75) Inventors: Theodore C. Smith, Wenatchee, WA (US); David J. Farenden, De Soto, KS (US); David W. Reed, Wenatchee, WA (US)

Correspondence Address: ALTHEIMER & GRAY, TEN SOUTH WACKER DRIVE, SUITE 4000, CHICAGO, IL, 60606-7482, US

(73) Assignee: Keyes Fibre Corporation, Wenatchee, WA (US)

(21) Appl. No.: 09/999,736

(22) Filed: Oct. 24, 2001

Related U.S. Application Data
(60) Provisional application No. 60/243,043, filed on Oct. 25, 2000.

(51) Int. Cl. B32B 1/08; B65D 1/00

(52) U.S. Cl. 428/34.2; 428/35.6; 229/407

(57) ABSTRACT

A molded pulp fruit tray. The molded pulp fruit tray contains carbon black pigment and is substantially uniformly black in color due to the presence of the pigment. The carbon black pigment may be added to a molded pulp furnish as an aqueous dispersion.

### CROSS REFERENCE TO RELATED APPLICATIONS

This application claims the benefit of U.S. Provisional application serial No. 60/243,043 filed Oct. 25, 2000, which is incorporated herein by reference in its entirety.

### FIELD OF THE INVENTION

The invention relates to fruit trays, such as trays for packing, shipping and displaying apples, which are made of molded pulp and which contain carbon black pigment.

### BACKGROUND OF THE INVENTION

Trays for packing, shipping and displaying fruit such as apples can be made from, among various materials, molded pulp. In the pulp molding process, a pulp “furnish” is prepared, which is an aqueous pulp slurry. The slurry can be made from, for example, waste newspaper. To form the molded article, the slurry is drawn by vacuum against molds of the appropriate shape. The product formed on the molds is then removed from the molds and dried to remove moisture, forming a shaped product having structural integrity. The art of pulp molding, including molding of molded pulp fruit trays, is well developed, and the basic techniques described above have been used for many years.

For decorative reasons, a dye is often added to the pulp furnish to impart a color to the final molded article. For example, the use of purple/blue dye in making molded pulp apple trays has become almost universal over the years.

### SUMMARY OF THE INVENTION

It has now been found that high loads of fine, particulate carbon black pigment can be added to a molded pulp furnish, to produce a molded pulp fruit tray strongly pigmented with the carbon black to produce a rich black color in the final molded fruit tray. The black pigment is securely attached to the tray, and does not transfer to the fruit.

### DESCRIPTION OF THE PREFERRED EMBODIMENTS

In accordance with the invention, the carbon black is simply added to the molded pulp furnish which is used to form the molded pulp fruit tray. Preferably, the carbon black is itself previously dispersed into an aqueous slurry before being added to the furnish. Upon thorough mixing of the carbon black into the furnish, the carbon black particles become evenly distributed throughout the furnish. A fixative chemical is added to the furnish prior to molding. When the pulp is formed and dried into shaped form using conventional pulp molding methodology, the final article has the carbon black particles fully retained and evenly distributed throughout its substance.

In addition to carbon black and a fixative, the furnish may contain other customary pulp molding auxiliaries, such as a wet strength additive, a sizing to impart water repellency to the final product, and retention and drainage aids to enhance production efficiency.

The carbon black may be added to the furnish as an aqueous dispersion of approximately 25% carbon solids in amounts between about 50-400 lbs of dispersion per ton dry fiber, which equates with a carbon black dosage of 12.5-100 lbs per ton of fiber. It has been found that even these very high carbon black loads are retained by the furnish and by the finished articles. For example, it has been found that the black color of the carbon black does not appear on the apples which are conventionally stored and transported in the tray according to this invention. It has also been found that these carbon black-loaded trays also maintain other necessary characteristics, such as rigidity and wet strength.

Preferred fixative chemicals are the salts of polycationic polymers, which are available in various chemical compositions and molecular weight categories. For example, the chloride salts of polyquaternary amines are available from Nalco Chemical Company.

The following example is provided as illustration of the invention and not as limitation.

### EXAMPLE

A newspaper-based pulp furnish was prepared containing approximately 1.5 percent pulp, and was maintained at pH between 6.5 and 7.5.

In addition to the pulp component, the furnish contained the following components, in quantities expressed as active ingredient per ton of pulp.

Sizing: 5 lbs of a commercial sizing agent “7541/7542”, available from Nalco Chemical Company.

Wet Strength Additive: 24 lbs. of “Ameres 8760”, available from Georgia Pacific Resins, Inc.

Fixative: 10 lbs. of Nalco 7607, available from Nalco Chemical Company.

Drainage aid: 1 lb. of Nalco 625, available from Nalco Chemical Company.

Carbon Black: 350 lbs. of Ajax Black 611, available from Solution Dispersions.

Apple packing trays were formed by vacuum molding of the above furnish. The apple trays, when formed and dried, showed a rich black color, uniformly distributed through the trays. When apples were packed and transported in the trays, there was no transfer of the black color onto the apples.

An alternative carbon black pigment is Black Pearls 4350 from Cabot Corporation. Other fixative chemicals may be selected from the range of commercially-available water-soluble polymers familiar to persons in the water treatment and water-based process industries. Also, there are a number of alternative furnish adjuvants which perform additional functions similar to those described above. For example, Kymeme 557 wet strength additive (Hercules Inc.) or similar alkyl ketene dimer/promoter compositions or neutral rosin ester emulsions, and other commercially available anionic polymers to assist in drainage, such as Nalco 8677 Plus and Nalco 8678 (Nalco Chemical Company). In addition to carbon black, the furnish may contain other color agents or dyes, such as purple/blue dye.

What is claimed is:

1. A molded pulp fruit tray which contains carbon black pigment and is substantially uniformly black in color due to the presence of said pigment.

2. A process of making a molded pulp fruit tray which is pigmented black, which comprises providing a molded pulp furnish, adding carbon black to the furnish, and molding the molded pulp article.

3. The process of claim 2, wherein the carbon black is added to the furnish as an aqueous dispersion.

4. The process of claim 2, wherein the furnish contains about 12.5-100 lbs. of carbon black per ton of pulp fiber.

5. The process of claim 2, wherein the furnish contains a fixative chemical.

6. The process of claim 3, wherein the furnish contains a fixative chemical.

7. The process of claim 4, wherein the furnish contains a fixative chemical.

8. The process of claim 5, wherein the furnish contains a wet strength chemical and a sizing.

9. The process of claim 6, wherein the furnish contains a wet strength chemical and a sizing.

10. The process of claim 7, wherein the furnish contains a wet strength chemical and a sizing.

11. A black colored fruit tray produced by the process of claim 2.

12. A black colored fruit tray produced by the process of claim 5.

13. A black colored fruit tray produced by the process of claim 8.

14. The fruit tray of claim 11 which is an apple tray.

15. The fruit tray of claim 12 which is an apple tray.

16. The fruit tray of claim 13 which is an apple tray.
